(19) United States
(12) Patent Application Publication
(10) Pub. No.: US 2023/0051044 A1
(43) Pub. Date: Feb. 16, 2023

(54) NECK-HUNG WORKING LAMP

(71) Applicant: NINGBO RONGFA ELECTRIC APPLIANCES CO., LTD., NINGBO CITY, (CN)

(72) Inventor: Junhui HU, NINGBO CITY, (CN)

(21) Appl. No.: 17/504,533

(22) Filed: Oct. 19, 2021

(30) Foreign Application Priority Data
Aug. 13, 2021 (CN) 202121899293.3

(51) Int. Cl. F21V 21/084

(52) U.S. Cl. CPC F21V 21/084

(57) ABSTRACT

The present invention relates to the field of working lamp technologies, which provides a neck-hung working lamp is provided, comprising a head band for being hung around a neck and lamp bodies connected at both ends of the head band. A mounting groove is disposed at both ends of the head band respectively, a cover plate is disposed at an outer side of the mounting groove, a telescopic gap is formed between the mounting groove and the cover plate, a telescoping mechanism is disposed at the telescopic gap, one end of the telescoping mechanism is connected with the lamp body, and the telescoping mechanism is used to adjust a distance between the head band and the lamp body. One of the advantages is to bring inconvenience to use in a neck-hung lamp in the prior art, the present invention provides a neck-hung working lamp.

### CROSS REFERENCE TO THE RELATED APPLICATIONS

This application is based upon and claims priority to Chinese Patent Application No. 202121899293.3, filed on Aug. 13, 2021, the entire contents of which are incorporated herein by reference.

### TECHNICAL FIELD

The present invention relates to the field of working lamp technologies, and in particular to a neck-hung working lamp.

### BACKGROUND

Along with social development, people have higher and higher requirements for comfortability and convenience of lives. For this reason, many things for improving human body comfortability and conveniences come into being. The illumination technology field also follows this way. At present, people like to use computers in warm quilt on bed at night with indoor lamps turned off. In this case, people, sometimes, cannot see keyboard clearly, while a table lamp is inconvenient to use. Those who read books while lying on bed may use a miniature clip lamp, but it is inconvenient to turn book. Therefore, a lamp having small limitation and ease of use is desired to meet the needs.

Chinese utility model patent CN212178714U provides a detachable neck-hung lamp, comprising a head band hung round a neck and a lamp body. Both ends of the head band is rotatably connected with a base in which a magnet is disposed, a tail of the lamp body is structurally matched with the base and provided internally with a magnet, a head of the lamp body is a luminous part, and a battery cabin is disposed in the lamp body. In use of the above neck-hung lamp, a distance between the lamp body and the head band is fixed so that the distance may be large or small for use. Thus, a user cannot adjust the distance based on actual requirements, bringing inconvenience to use.

### SUMMARY

In order to solve the technical problems that a fixed distance between a lamp body and a head band may be large or small for use and cannot be adjusted based on actual requirements and hence will bring inconvenience to use in a neck-hung lamp in the prior art, the present invention provides a neck-hung working lamp.

In order to solve the above technical problems, the present invention employs the following technical solution. A neck-hung working lamp is provided, comprising a head band for being hung around a neck and lamp bodies connected at both ends of the head band. A mounting groove is disposed at both ends of the head band respectively, a cover plate is disposed at an outer side of the mounting groove, a telescopic gap is formed between the mounting groove and the cover plate, a telescoping mechanism is disposed at the telescopic gap, one end of the telescoping mechanism is connected with the lamp body, and the telescoping mechanism is used to adjust a distance between the head band and the lamp body.

Compared with the prior art, the present invention has the following advantages: the distance between the head band and the lamp body can be adaptively adjusted by disposing the telescoping mechanism between the head band and the lamp body, thereby bringing ease of use and improving convenience of use.

In the above neck-hung working lamp, the telescoping mechanism comprises a telescoping rod, a locking block, an elastic piece, and a pressing block. The locking block is movably connected in the mounting groove, and the telescoping rod is slidably connected in the telescopic gap and located between the locking block and the cover plate. The telescoping rod is located at an outer side of the head band. One end of the telescoping rod extends out of the telescopic gap to connect with the lamp body, and the other end of the telescoping rod extends out of the telescopic gap to form a limiting block. The telescoping rod drives the lamp body to slide close to or away from the head band. A side of the telescoping rod located in the telescopic gap is abutted against an inner side of the cover plate, and the other side of the telescoping rod is abutted against the locking block. One side of the locking block is connected with the elastic piece, one end of which is connected with an inner side of the cover plate, and the other side of the locking block is connected with the pressing block. One end of the pressing block protrudes out of the telescopic gap and the cover plate. The pressing block drives the locking block to move along a direction perpendicular to a slide direction of the telescoping rod in the mounting groove, thereby locking or unlocking the telescoping rod.

When the distance between the lamp body and the head band is adjusted, the pressing block is pressed to drive the locking block to move away from the telescoping rod, thus unlocking the telescoping rod. In this case, the telescoping rod may be slid close to or away from the head band by hand, thus adjusting the distance between the lamp body and the head band. After adjustment, the pressing block is released and the locking block is moved close to the telescoping rod under the action of the elastic piece and abutted against a side of the telescoping rod, thus locking the telescoping rod and avoiding back and forth movement of the telescoping rod during use.

In the above neck-hung working lamp, at least one fitting groove is disposed at a side of the telescoping rod close to the locking block, and at least one locking column corresponding to the at least one fitting groove is disposed on the locking block. When the locking block limits the telescoping rod, the locking column on the locking block is fitted into the fitting groove on the telescoping rod, thus locking the telescoping rod. When the locking block unlocks the telescoping rod, the locking column on the locking block moves out of the fitting groove on the telescoping rod, so that the telescoping rod can be slid by hand.

In the above neck-hung working lamp, three locking columns are disposed and uniformly distributed in a spacing at two ends and a middle position of the locking block; a plurality of fitting grooves are disposed, and the plurality of fitting grooves are uniformly distributed in a spacing at a side of the telescoping rod along a slide direction of the telescoping rod. When the locking block limits the telescoping rod, the three locking columns on the locking block are fitted into the fitting grooves of the telescoping rod, thus achieving better and more stable locking for the telescoping rod.

In the above neck-hung working lamp, at least one limiting groove corresponding to the locking column is disposed at an inner side of the cover plate, and the limiting groove is located at a side away from the pressing block. When the pressing block is pressed to move the locking block away from the telescoping rod, the locking column on the locking block moves out of the fitting groove of the telescoping rod and enters the limiting groove at the inner side of the cover plate. Thus, the movement of the locking block is limited and guided, avoiding interference.

In the above neck-hung working lamp, the elastic piece is a telescopic spring.

In the above neck-hung working lamp, a mounting hole corresponding to the telescopic spring is disposed on the locking block, and one end of the telescopic spring is connected in the mounting hole.

In the above neck-hung working lamp, a spring groove corresponding to the telescopic spring is disposed at an inner side of the cover plate, a spring column is disposed in the spring groove, and one end of the telescopic spring is sleeved on the spring column.

In the above neck-hung working lamp, the cover plate is connected at both sides of the head band, a pressing hole corresponding to the pressing block is disposed at a side of the cover plate, and the pressing block penetrates through the pressing hole to connect with the locking block.

In the above neck-hung working lamp, a width of the limiting block is greater than a width of the telescopic gap, and the limiting block and the telescoping rod are integrally formed. The limiting block is disposed at an end of the telescoping rod. When the telescoping rod is moved away from the head band by pull, the telescoping rod will not be pulled out of the telescopic gap because the width of the limiting block is greater than the width of the telescopic gap.

### BRIEF DESCRIPTIONS OF THE DRAWINGS

FIG. 1 is a schematic diagram of an entire structure of an embodiment of the present invention.

FIG. 2 is a structural schematic diagram of a lamp body according to an embodiment of the present invention.

FIG. 3 is a schematic diagram 1 of a partial structure of an embodiment of the present invention.

FIG. 4 is a schematic diagram 2 of a partial structure of an embodiment of the present invention.

FIG. 5 is a structural schematic diagram of a cover plate according to an embodiment of the present invention.

FIG. 6 is an exploded view of a partial structure of an embodiment of the present invention.

Numerals of the drawings are described as follows: 1. head band, 2. lamp body, 3. telescoping mechanism, 31. mounting groove, 32. cover plate, 321. pressing hole, 322. spring groove, 323. spring column, 33. locking block, 331. mounting hole, 34. elastic piece, 35. pressing block, 36. telescoping rod, 361. limiting block, 37. fitting groove, 38. locking column, and 39. limiting groove.

### DETAILED DESCRIPTIONS OF EMBODIMENTS

The technical solution of the present invention will be further described in detail below in combination with specific embodiments and accompanying drawings. The present invention is not limited to these embodiments.

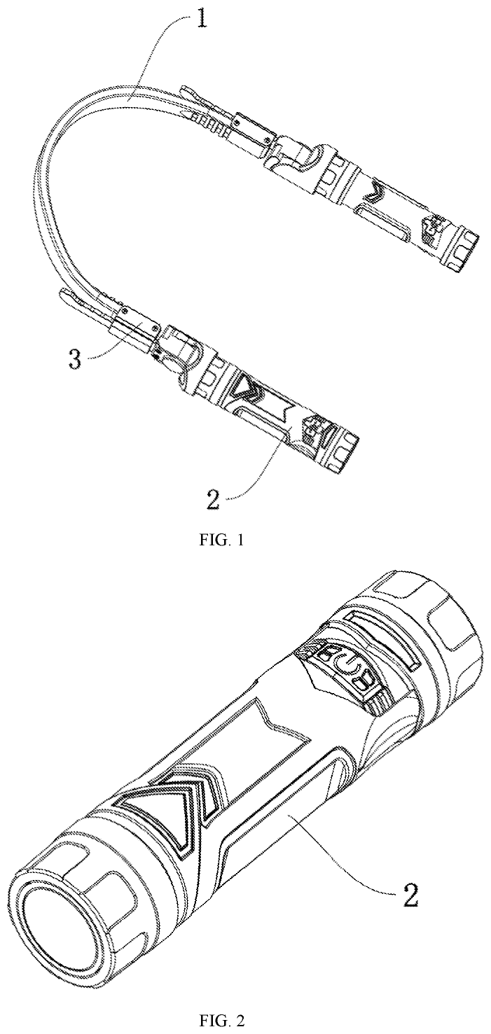

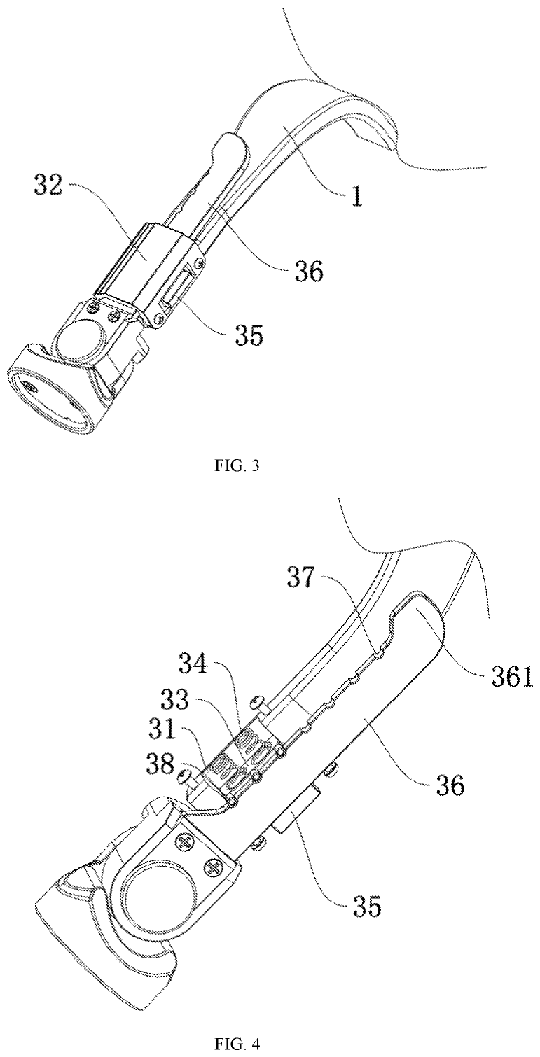

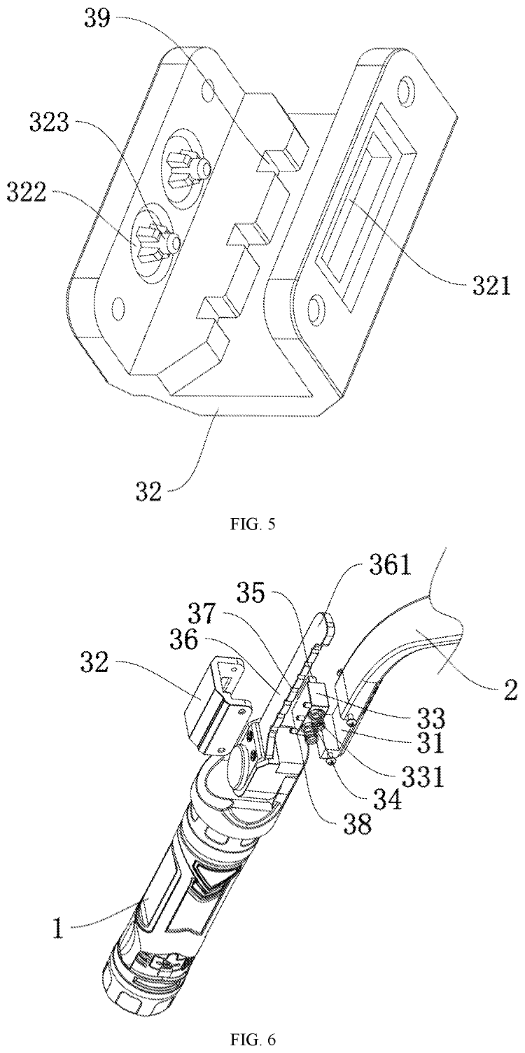

As shown in FIGS. 1-6, the present invention provides a neck-hung working lamp, comprising a head band 1 for being hung around a neck and lamp bodies 2 connected at both ends of the head band 1. A mounting groove 31 is disposed at both ends of the head band 1 respectively, a cover plate 32 is disposed at an outer side of the mounting groove 31, a telescopic gap is formed between the mounting groove 31 and the cover plate 32, a telescoping mechanism 3 is disposed at the telescopic gap, one end of the telescoping mechanism 3 is connected with the lamp body 2, and the telescoping mechanism 3 is used to adjust a distance between the head band 1 and the lamp body 2. In this way, use requirements can be satisfied and convenience of use can be improved.

The telescoping mechanism 3 comprises a telescoping rod 36, a locking block 33, an elastic piece 34, and a pressing block 35. The locking block 33 is movably connected in the mounting groove 31, and the telescoping rod 36 is slidably connected in the telescopic gap and located between the locking block 33 and the cover plate 32. The telescoping rod 36 is located at an outer side of the head band 1. One end of the telescoping rod 36 extends out of the telescopic gap to connect with the lamp body 2, and the other end of the telescoping rod 36 extends out of the telescopic gap to form a limiting block 361. The telescoping rod 36 drives the lamp body 2 to slide close to or away from the head band 1. A side of the telescoping rod 36 located in the telescopic gap is abutted against an inner side of the cover plate 32, and the other side of the telescoping rod 36 is abutted against the locking block 33. A side of the locking block 33 is connected with the elastic piece 34, one end of which is connected with an inner side of the cover plate 32, and the other side of the locking block 33 is connected with the pressing block 35. One end of the pressing block 35 protrudes out of the telescopic gap and the cover plate 32. The pressing block 35 drives the locking block 33 to move along a direction perpendicular to a slide direction of the telescoping rod 36 in the mounting groove 31, thereby locking or unlocking the telescoping rod 36.

A plurality of fitting grooves 37 are disposed at a side of the telescoping rod 36 close to the locking block 33, and the fitting grooves 37 are uniformly distributed in a spacing at the side of the telescoping rod 36 along a slide direction of the telescoping rod 36, and three locking columns 38 corresponding to the fitting grooves 37 are disposed on the locking block 33 and uniformly distributed in a spacing at two ends and a middle position of the locking block 33. At least one limiting groove 39 corresponding to the locking column 38 is disposed at an inner side of the cover plate 32, and located at a side away from the pressing block 35.

The cover plate 32 is connected at both sides of the head band 1, a pressing hole 321 corresponding to the pressing block 35 is disposed at a side of the cover plate 32, and the pressing block 35 penetrates through the pressing hole 321 to connect with the locking block 33.

The elastic piece 34 is a telescopic spring, a mounting hole 331 corresponding to the telescopic spring is disposed on the locking block 33, and one end of the telescopic spring is connected in the mounting hole 331. A spring groove 322 corresponding to the telescopic spring is disposed at an inner side of the cover plate 32, a spring column 323 is disposed in the spring groove 322, and one end of the telescopic spring is sleeved on the spring column 323.

A width of the limiting block 361 is greater than a width of the telescopic gap, and the limiting block 361 and the telescoping rod 36 are integrally formed.

In use, a lamp is hung on a neck by use of the head band 1, eliminating a positional limitation and need of double hands. The distance between the head band 1 and the lamp body 2 can be adjusted through the telescoping mechanism 3 according to the actual requirements, thereby providing good use convenience and flexibility.

The specific embodiments described herein are merely illustrative of the present invention. Various modifications, supplementations, or similar substitutions made to the described specific embodiments by those skilled in the art shall all fall within the scope of protection of the present invention.

1. A neck-hung working lamp is provided, comprising a head band (1) for being hung around a neck and lamp bodies (2) connected at both ends of the head band (1), wherein a mounting groove (31) is disposed at both ends of the head band (1) respectively, a cover plate (32) is disposed at an outer side of the mounting groove (31), a telescopic gap is formed between the mounting groove (31) and the cover plate (32), a telescoping mechanism (3) is disposed at the telescopic gap, one end of the telescoping mechanism (3) is connected with the lamp body (2), and the telescoping mechanism (3) is used to adjust a distance between the head band (1) and the lamp body (2).

2. The neck-hung working lamp of claim 1, wherein the telescoping mechanism (3) comprises a telescoping rod (36), a locking block (33), an elastic piece (34), and a pressing block (35); the locking block (33) is movably connected in the mounting groove (31), and the telescoping rod (36) is slidably connected in the telescopic gap and located between the locking block (33) and the cover plate (32); the telescoping rod (36) is located at an outer side of the head band (1); one end of the telescoping rod (36) extends out of the telescopic gap to connect with the lamp body (2), and the other end of the telescoping rod (36) extends out of the telescopic gap to form a limiting block (361); the telescoping rod (36) drives the lamp body (2) to slide close to or away from the head band (1); a side of the telescoping rod (36) located in the telescopic gap is abutted against an inner side of the cover plate (32), and the other side of the telescoping rod is abutted against the locking block (33); one side of the locking block (33) is connected with the elastic piece (34), one end of the elastic piece (34) is connected with an inner side of the cover plate (32), and the other side of the locking block (33) is connected with the pressing block (35); one end of the pressing block (35) protrudes out of the telescopic gap and the cover plate (32); the pressing block (35) drives the locking block (33) to move along a direction perpendicular to a slide direction of the telescoping rod (36) in the mounting groove (31), thereby locking or unlocking the telescoping rod (36).

3. The neck-hung working lamp of claim 2, wherein at least one fitting groove (37) is disposed at a side of the telescoping rod (36) close to the locking block (33), and at least one locking column (38) corresponding to the at least one fitting groove (37) is disposed on the locking block (33).

4. The neck-hung working lamp of claim 3, wherein three locking columns (38) are disposed and uniformly distributed in a spacing at two ends and a middle position of the locking block (33); a plurality of fitting grooves (37) are disposed, and the plurality of fitting grooves (37) are uniformly distributed in a spacing at a side of the telescoping rod (36) along a slide direction of the telescoping rod (36).

5. The neck-hung working lamp of claim 3, wherein at least one limiting groove (39) corresponding to the locking column (38) is disposed at an inner side of the cover plate (32), and the limiting groove (39) is located at a side away from the pressing block (35).

6. The neck-hung working lamp of claim 2, wherein the elastic piece (34) is a telescopic spring.

7. The neck-hung working lamp of claim 6, wherein a mounting hole (331) corresponding to the telescopic spring is disposed on the locking block (33), and one end of the telescopic spring is connected in the mounting hole (331).

8. The neck-hung working lamp of claim 6, wherein a spring groove (322) corresponding to the telescopic spring is disposed at an inner side of the cover plate (32), a spring column (323) is disposed in the spring groove (322), and one end of the telescopic spring is sleeved on the spring column (323).

9. The neck-hung working lamp of claim 8, wherein the cover plate (32) is connected at both sides of the head band (1), a pressing hole (321) corresponding to the pressing block (35) is disposed at a side of the cover plate (32), and the pressing block (35) penetrates through the pressing hole (321) to connect with the locking block (33).

10. The neck-hung working lamp of claim 2, wherein a width of the limiting block (361) is greater than a width of the telescopic gap, and the limiting block (361) and the telescoping rod (36) are integrally formed.
